(19) United States
(12) Patent Application Publication
(10) Pub. No.: US 2024/0199349 A1
(43) Pub. Date: Jun. 20, 2024

(54) SYSTEMS AND METHODS FOR AUTOMATED PACKAGING AND PROCESSING WITH STATIC AND DYNAMIC PAYLOAD GUARDS

(71) Applicant: Berkshire Grey Operating Company, Inc., Bedford, MA (US)

(72) Inventors: Ashwin DESHPANDE, Lexington, MA (US); Jeremy SASLAW, Cambridge, MA (US); Luis GALUP, Sudbury, MA (US); Kyle BROWN, Westford, MA (US); Ryan O'HERN, Reading, MA (US); Michael KOSSYREV, Ayer, MA (US); Vitalii RUSSINKOVSKII, Lexington, MA (US); Christopher GEYER, Arlington, MA (US); Benjamin COHEN, Somerville, MA (US)

(21) Appl. No.: 18/541,075

(22) Filed: Dec. 15, 2023

Related U.S. Application Data
(60) Provisional application No. 63/433,211, filed on Dec. 16, 2022.

(51) Int. Cl. B65G 47/90

(52) U.S. Cl. CPC B65G 47/905; B65G 2201/0238

(57) ABSTRACT

A system is disclosed for processing objects using a programmable motion device. The system includes an end-effector of the programmable motion device for grasping an object from an in-feed container, and a control system for determining a payload guard for the selected object. The payload guard includes pointcloud data regarding volumetric data that include a volume occupied by the selected object, and the payload guard is determined responsive to at least one characteristic of the selected object and is provided specific to the selected object.

### PRIORITY

The present application claims priority to U.S. Provisional Patent Application No. 63/433,211, filed Dec. 16, 2022, the disclosure of which is hereby incorporated by reference in its entirety.

### BACKGROUND

The invention generally relates to automated sortation and other processing systems, and relates in particular to automated systems for handling and processing objects such as parcels, packages, articles, goods, etc. for e-commerce distribution, sortation, facilities replenishment, and automated storage and retrieval (AS/RS) systems.

Shipment centers for packaging and shipping a limited range of objects, for example, from a source company that manufactures the objects, may require only systems and processes that accommodate the limited range of the same objects repeatedly. Third party shipment centers on the other hand, that receive a wide variety of objects, must utilize systems and processes that must accommodate the wide variety of objects.

In e-commerce order fulfillment centers, for example, human personnel pack units of objects into shipping containers like boxes or polybags. One of the last steps in an order fulfillment center is packing one or more objects into a shipping container or bag. Units of an order destined for a customer are typically packed by hand at pack stations. Order fulfillment centers do this for a number of reasons.

For example, objects typically need to be packed in shipping materials. Objects need to be put in boxes or bags to protect the objects, but are not generally stored in the materials in which they are shipped, but rather need to be packed on-the-fly after an order for the object has been received.

Additionally, handling a wide variety of objects on common conveyance and processing systems however, present challenges, particularly where objects have any of low pose authority or low placement authority. Pose authority is the ability to place an object into a desired position and orientation, and placement authority is the ability of an object to remain in a position and orientation at which it is placed. If for example, an object with low pose authority or low placement authority is to be moved on a conveyance system that may undergo linear or angular acceleration or deceleration, the object may fall over and/or may fall off of the conveyance system.

These requirements become more challenging as the number of goods and the number of destination locations increase, and further where the system needs to operate in busy work cell environments with static and moving obstacles. There remains a need therefore, for an automated system for handling a wide variety of objects in object processing systems in busy work cell environments with static and moving obstacles.

### SUMMARY

In accordance with an aspect, the invention provides a system for processing objects using a programmable motion device. The system includes an end-effector of the programmable motion device for grasping an object from an in-feed container, and a control system for determining a payload guard for the selected object. The payload guard includes pointcloud data regarding volumetric data that include a volume occupied by the selected object, and the payload guard is determined responsive to at least one characteristic of the selected object and is provided specific to the selected object.

In accordance with another aspect, the invention provides a method of processing objects using a programmable motion device. The method includes grasping an object from an in-feed container using an end-effector of the programmable motion device, lifting the object from the in-feed container, and determining a payload guard for the grasped object, said payload guard is derived from pointcloud data regarding volumetric data that include a volume occupied by the grasped object, said payload guard being determined responsive to at least one characteristic of the grasped object and is provided specific to the grasped object.

In accordance with a further aspect, the invention provides a system for processing objects using a programmable motion device. The system includes an end-effector of the programmable motion device for grasping an object, a perception system for determining perception data regarding the object, and a control system for determining a payload guard for the grasped object. The payload guard is derived from pointcloud data regarding volumetric data that include a volume occupied by the grasped object, and the payload guard is determined responsive to the perception data.

### BRIEF DESCRIPTION OF THE DRAWINGS

The following description may be further understood with reference to the accompanying drawings in which:

FIG. 1 shows an illustrative diagrammatic view of an object processing system in accordance an aspect of the present invention that includes an in-line object processing station;

FIG. 2 shows an illustrative diagrammatic view of an object processing system in accordance with another aspect of the present invention that includes a pick-cell object processing station with an auto-bagging system;

FIG. 3 shows an illustrative diagrammatic enlarged view of the object processing system of FIG. 2 showing the opening of the auto-bagging system;

FIG. 4 shows an illustrative diagrammatic view of an end-effector with a vacuum cup grasping an object in an object processing system in accordance an aspect of the present invention;

FIG. 5 shows an illustrative diagrammatic plan view of a plurality of positions of the object of FIG. 4 showing a relation of sides to radius;

FIG. 6 shows an illustrative diagrammatic plan view of a plurality of positions of the object of FIG. 4 where the disk of the suction cup does not overlap with any edge of the object;

FIG. 7 shows an illustrative diagrammatic view of an end-effector with a vacuum cup grasping the object of FIG. 4 showing an axis-aligned bounding cylinder;

FIG. 8 shows an illustrative diagrammatic plan view of a plurality of positions of the object showing the axis-aligned bounding cylinder of FIG. 7;

FIG. 9 shows an illustrative diagrammatic view of an end-effector with a conformable cup holding an object in a way that is not balanced;

FIG. 10 shows an illustrative diagrammatic view of the object in a plurality of non-balanced positions showing a bounding box;

FIG. 11 shows an illustrative diagrammatic view of the object in the plurality of non-balanced positions of FIG. 10 showing a convex bounding hull;

FIG. 12 shows an illustrative diagrammatic plan view of an object in a tote showing a cylindrical payload guard;

FIG. 13 shows an illustrative diagrammatic plan view of an object in a tote showing a situation-bounded payload guard;

FIG. 14 shows an illustrative graphical representation of an image of a bin containing objects to be processed;

FIG. 15 shows an illustrative graphical representation of a segmentation of a pointcloud of the contents of the bin of FIG. 14;

FIG. 16 shows an illustrative diagrammatic enlarged view of a portion of the system of FIG. 1 showing a pose-in-hand perception system;

FIG. 17 shows an illustrative diagrammatic underside view of the end-effector of the system of FIG. 16 showing the object and an underside of the end-effector;

FIG. 18 shows the pointcloud data of the end-effector and the object of FIG. 17;

FIG. 19 shows an illustrative diagrammatic side view of the end-effector of the system of FIG. 2 showing the object and a side view of the end-effector;

FIG. 20 shows an illustrative diagrammatic enlarged view of an end-effector and vacuum cup grasping an object within a bag;

FIG. 21 shows an illustrative diagrammatic enlarged view of an end-effector and vacuum cup grasping an object within a larger bag that may swing;

FIG. 22 shows an illustrative diagrammatic view of an object processing system in accordance with an aspect of the present invention that involves the placement of objects into openings of bags;

FIG. 23 shows an illustrative diagrammatic view of the object processing system of FIG. 22 showing the end-effector positioned to place the object into a bag opening;

FIG. 24 shows an illustrative diagrammatic view of an object processing system in accordance with an aspect of the present invention that involves the placement of objects into open-ended cubbies; and

FIGS. 25A and 25B show illustrative diagrammatic enlarged views of the object processing system of FIG. 24 showing the end-effector not aligned with a cubbie opening (FIG. 25A) and showing the end-effector rotated to be aligned with the cubbie opening (FIG. 25B).

The drawings are showing for illustrative purposes only.

### DETAILED DESCRIPTION

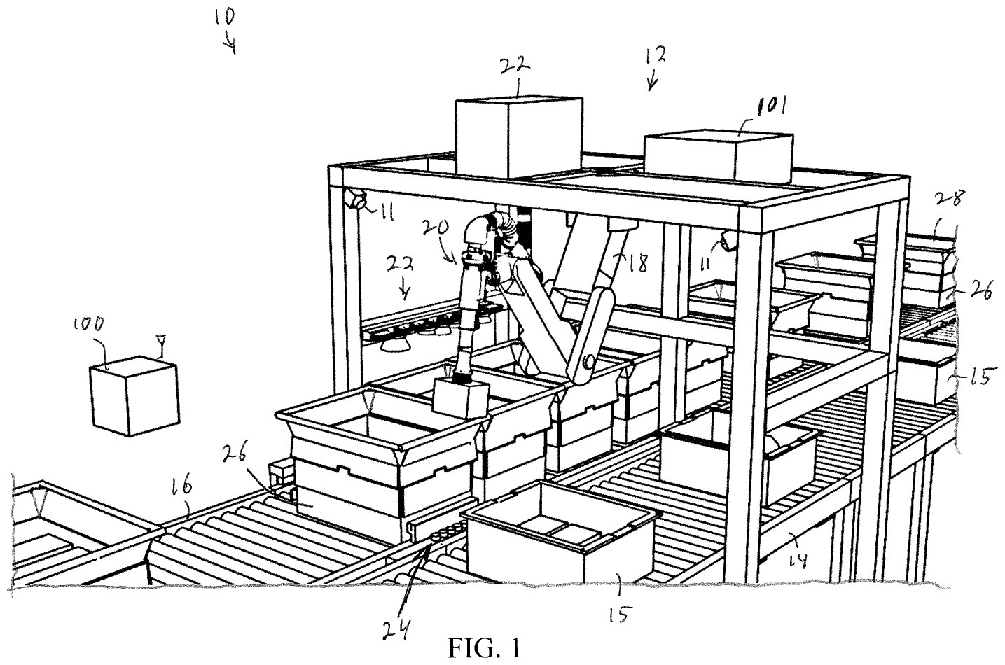

In accordance with various aspects, the invention provides an object processing system 10 that includes a processing station 12 in communication with an input conveyance system 14 and a processing conveyance system 16 as shown in FIG. 1. The processing station 12 includes a programmable motion device 18 with an attached end-effector 20 at a distal end thereof. The end-effector 20 may be coupled (e.g., via a hose) to a vacuum source 22, and the operation of the programmable motion device may be provided by one or more computer processing systems 100, 101 in communication with the programmable motion device and all perception units 11, conveyors 14, 16 and further processing systems disclosed herein.

The object processing system 10 further includes a vacuum cup changing rack 22 that may be accessed by the programmable motion device 12 to exchange vacuum cups attached to the end-effector 20 as disclosed, for example, in U.S. Patent Application Publication No. 2019/0217471, the disclosure of which is hereby incorporated by reference in its entirety. One or more pose-in-hand scanners 24 are also provided near the area where objects are picked from in-feed bins or totes 15 for placement into processing containers 26 such as boxes. The processing containers 26 may include covers 28 that hold box flaps against the box in an open position, and provide a funneled opening for each container 26. When containers 26 with covers 28 are adjacent one another, the covers may contact each other providing adjacent container openings with no area between containers being exposed and into which objects may accidently fall.

While the system 10 moves objects out of in-feed totes 15 on the in-feed conveyance system 14 and into a processing container 26 on the processing conveyance system 16, the system needs to ensure that the object it is holding does not collide with any other parts of the work environment (such as the cup-changing rack 22). If the object collides with the environment it could cause damage to the environment (the cup-changing rack may be fragile) or it could cause damage to the object itself, or it could cause the gripper to drop the object. It is therefore important to plan motions in the environment that are unlikely to cause collisions between the held object and the work cell environment, including for example, the covers 28 when lifting and moving the objects.

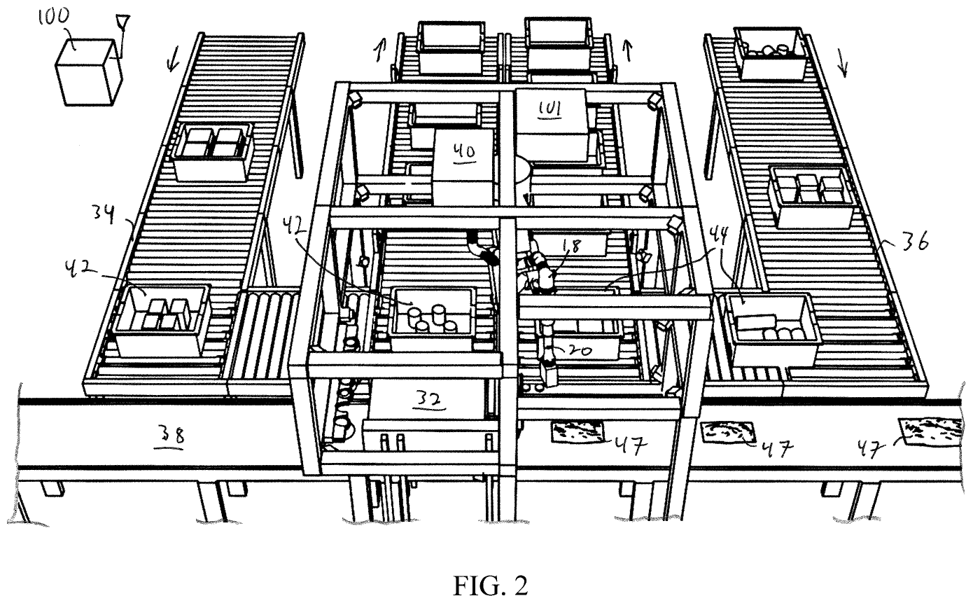

In accordance with various aspects, systems and methods of the invention utilize payload guards in automated object processing systems that include programmable motion devices, such as for example the in-line object processing station 12 shown in FIG. 1 or a pick cell 30 as shown in FIG. 2. The pick cell 30 of FIG. 2 includes an auto-bagging system 32 and the programmable motion device 18 with the attached end-effector 20 that moves objects from input conveyance systems 34, 36 to the auto-bagging system 32. Once bagged, the objects (in bags) 47 fall to a processing conveyance system 38. The end-effector 40 may be coupled to a vacuum source 40, and the operation of the programmable motion device 18, perception units 31, 33, 35 conveyors 34, 36 and the auto-bagging system 32 may be provided by a one or more computer processing systems 100, 101.

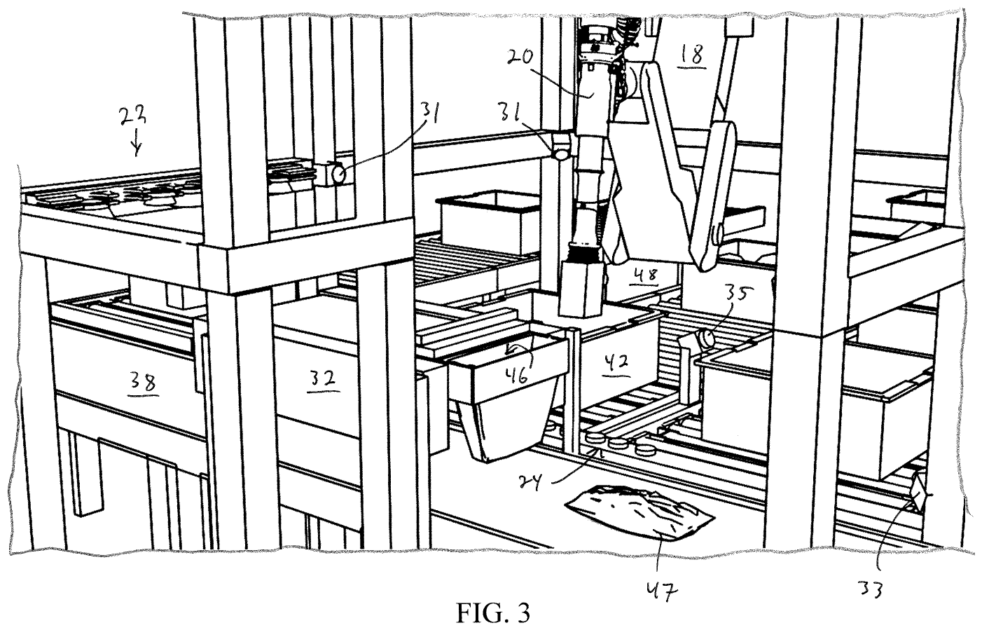

The system 30 takes an object out of an in-feed tote 42, 44 and places it into a chute or opening 46 of the auto-bagging system 32 as shown in FIG. 3 using, for example, a vacuum cup 48 attached to the end-effector 20. While the system 30 moves objects out of the in-feed totes 42, 44 and into the auto-bagging system 32 it needs to ensure that the object it is holding does not collide with any other parts of the work cell. Again, it is important to plan motions in the environment that are unlikely to cause collisions between the held object and the work cell environment.

Motion planning in programmable motion devices (e.g., robots) generally involves finding a sequence of robot arm joint configurations, e.g., a trajectory, that reaches a desired destination and avoid collisions with the environment at each part of the trajectory. See for example, Planning Algorithms, Steven M. LaValle, Cambridge University Press, 2006. Certain motion planning systems include algorithms such as Rapidly-exploring Random Tree (RRT) and Rapidly-Exploring Random Trees: A New Tool for Path Planning by Steven M. Lavalle, Technical Report, Computer Science Department, Iowa State University, October 1998 that include collision checks where a geometric model of the robot is checked against a geometric model of the environment. The geometry of the robot is represented digitally and the given test configuration is used to transform the robot to the given set of positions, orientations or joint angles, which are then tested for collision against the digitized model of the environment as well as the robot itself (to avoid self-collision).

If however, the robot is holding an object, e.g., with some kind of robotic gripper, then care must be taken to avoid collision of the held object with the robot or the environment. To achieve this, some representation of the object is needed so as to be incorporated into the collision check test. This is straightforward if the object's position and orientation relative to the gripper is known or can be controlled ahead of time. For example, in certain manufacturing applications a special gripper may be designed to pick up a part in a specific place on the part, in which case the held object geometry can be directly attached to the end-effector/gripper in a place that accurately represents reality.

There are, however, many cases where information regarding an object that is held cannot be tightly controlled, such as when picking up a product or SKU from an inventory tote coming from an AS/RS. The product may be stored in many arbitrary, uncontrolled positions and orientations in the tote. The robot may pick up the item with a vacuum gripper, for instance, and where and how the item is then held could be completely unknown. A geometric model for a box picked up in its center, for example, would need to be different from a geometric model needed for a box picked on its edge.

Another consideration is that there may be compliance in the linkage between the end-effector and the held object. For example, the bellows in a suction cup may deflect or bend as the object accelerates, or as the orientation of the gripper changes. The position and orientation of the object relative to the robot's end-effector may therefore not be constant. Further, the object itself may be deformable. Both of these considerations add uncertainty to the actual volumes in which the held object occupies as the robot's end-effector moves in space. All of these considerations are incredibly important for robot work cells that do not have a lot of room. In such cases it is therefore important during the formulation of motions to take into account the geometry of the held object to check for potential collision.

A challenge however in providing such planning is that overly conservative bounds may lead to trajectory planning failure in crowded work environments. It is also important that whatever geometry is attached to a model be as tight a bound as can be practically made. If the attached geometry is overly conservative (by being much larger than the actual object or the volume it could possibly hold), then there may be no collision-free path through the virtual environment. This leads to trajectory planning failure: the inability to generate a collision-free path, or in other cases a suboptimal path by virtue of the overly conservative bounds. Such overly conservative bounds could cause a system to be unable to generate a path in situations where many collision-free paths exist in reality (with no or smaller bounds).

The virtual geometry that is attached to the end-effector to perform collision checks is referred to herein as a payload guard. The payload guard can be thought of as a worst-case volume that envelopes the item. The motion planner assumes that the payload guard is attached to the robot's end-effector as it attempts to find collision-free plans through the environment from point A to point B. Disclosed herein are various ways to compute and use payload guards with and without uncertainty in how the object is held.

The term trajectory generally refers to a list of joint configurations (e.g., joint angles) and times relative to the start of motion. The robot arm controls its motors to achieve given angles at given times. Robot arms may for example have 6 joint angles (6DOF), and when a yawing gripper is used as shown in FIGS. 1 and 2, the system may have 7 degrees of freedom (7DOF). The forward kinematics are the mapping from joint configurations (6- or 7DOF) to coordinate frames (typically at the end-effector or suction cup). The inverse kinematics determine the joint configurations that can attain a given coordinate frame at the end-effector (or vacuum cup). The acronym AABB as used herein refers to an axis-aligned bounding box, the axes to which the box is aligned depends on the choice of coordinate frame. The term pose refers to position (x,y,z) and orientation (e.g., roll, pitch, yaw) or other orientation representation such as quaternion, matrix, or axis-angle, generally providing a total of six degrees of freedom.

For sensors that capture images or pointclouds, the extrinsic parameters are the six parameters that encode the position and orientation of the sensor relative to the robot's coordinate system. The extrinsic calibration allows the system to put points from a pointcloud in the robot's coordinate system, e.g., or to project virtual points in the robot's coordinate system to an image. The term stock keeping unit (SKU) refers to an identity of a certain product. As discussed above an automated storage and retrieval system (ASRS) refers to an automated system of cranes or shuttles or robots that deliver totes to stations. The warehouse management system (WMS) provides a source of information about a SKU's dimensions or weights. The term sorted dimensions refers to the triple (d₁,d₂,d₃) where d₁≤d₂≤d₃, representing the dimensions of a SKU, for example, in cm. A pointcloud is a list of 3D points generated by a 3D camera such as a stereo camera system, a LIDAR imaging system, a time-of-flight (TOF) camera system, or a structured light camera system. If objects are presented to the picking system such that the end-effector is presented each object's largest face up (LFU) then the system knows that the object's largest face of the minimum volume enclosing cuboid is face up. This implies that the shortest dimension, d₁, is parallel to the vertical.

In accordance with various aspects of the present invention, systems and methods are provided for generating and using payload guards in a variety of applications with differing fidelity (exactness) requirements. Differing approaches to providing payload guards provide varying orders of conservatism, or in other words increasing level of fidelity to the envelope of worst-case outcomes. A set of concepts based on kinematics and logic discussed below use increasing fidelity of models. Additional disclosed approaches add increasing information from sensors, and further approaches are hybrid approaches.

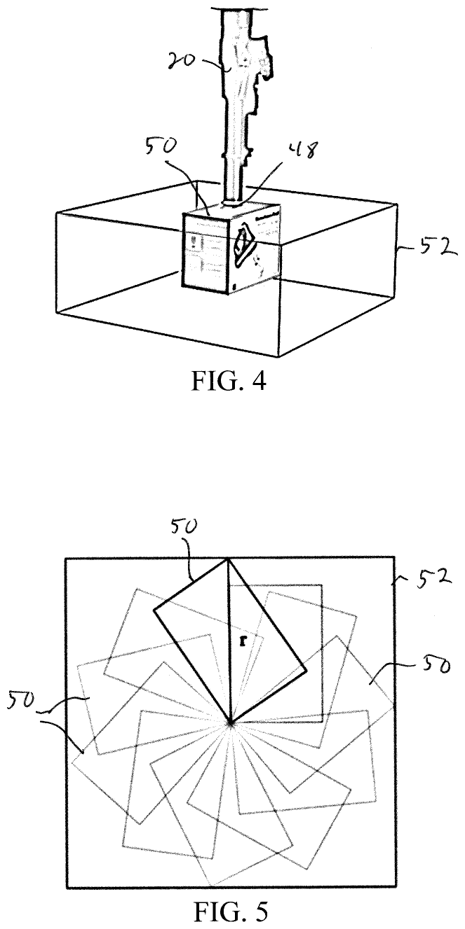

System parameters may provide that an object processing system is able to handle products of certain dimensions and weights. A robot, for example, may only be able to handle items smaller than a 35 cm×25 cm×25 cm cuboid. FIG. 4 shows the end-effector 20 with a vacuum cup 48 grasping an object 50. A virtual bounding box shown at 52 may be defined with respect to the distal end of the vacuum cup 48. For planning the motion after picking an object, the system may construct the axis-aligned bounding box (AABB) 52, the top plane of which is centered on the gripper whose horizontal sides are of length 2*r where r²=(d₂)²+(d₃)², i.e., the hypotenuse of the two longest dimensions. FIG. 5 shows a plurality of positions of the object 50 that give rise to the relation that each of the four sides has a length of 2*r.

If the object can be guaranteed to be LFU, then the system will define d₁ as the height of the bounding box, otherwise the system will let the height be d₃. This bounding cuboid is then virtually attached to the gripping coordinate frame and used to avoid collisions during motion planning. The coordinate frame for the purposes of axis-alignment is chosen at the time of the grasp and can be a fixed coordinate frame relative to the robot, or a coordinate frame derived for instance from the pose of a tote that is picked from (which may vary tote to tote, pick to pick). This AABB defines the payload guard and because of its construction will contain the object regardless of which part of the object 50 is picked.

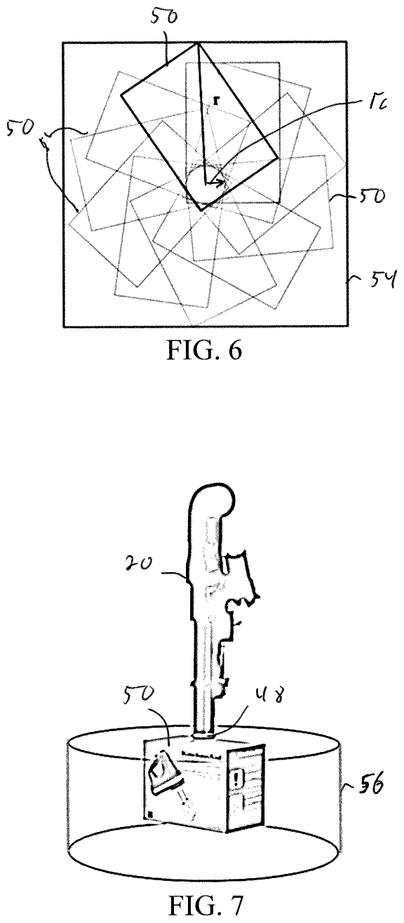

If the gripper is a vacuum cup and if it is assumed that the vacuum cup is fully within one of the pick faces, then the tightness of the model may be improved. The system may adjust r according to the radius of the cup, r_{c} such that r²=(d₂−r_{c})²−(d₃−r_{c})² as shown in FIG. 6 where the disk of the suction cup does not overlap with any edge of the object. This yields a slightly smaller boundary box 54 as shown in FIG. 6, where r_{c} is the radius of the vacuum cup.

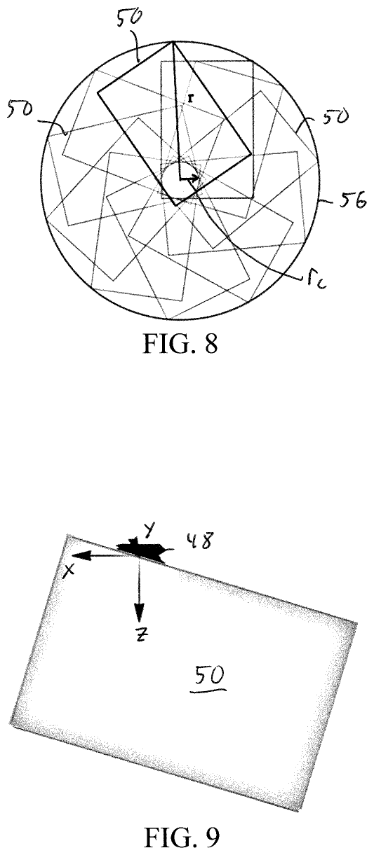

A benefit of using bounding boxes (cubes) is that it facilitates the mathematical processing speed. Further tighter bounds, but with more complex geometry, may be constructed by using a cylinder of radius r insted of a box. FIG. 7 shows end-effector 20 with the vacuum cup 48 gasping the object 50. A virtual bounding cylinder shown at 56 is defined with respect to the distal end of the vacuum cup 48. For planning the motion after picking an object, the system may construct the axis-aligned bounding cylinder 56, the top plane of which is centered on the gripper, with the cylinder 56 having a radius of r where r²=(d₂−r_{c})²−(d₃−r_{c})² again, the hypotenuse of the two longest dimensions. FIG. 8 shows a plurality of positions of the object 50 showing that the bounding cylinder 56 has a radius r.

The approaches described above use the maximum dimensions that can be handled by the robot. The bounds generated may be much larger than the actual item being picked. This might induce slower motions than if the motion planning system had a tighter bound, and thus be less constrained in its motions in the virtual environment.

In some applications SKUs come to a picking robot in homogeneous totes, as for example when they come from an AS/RS. The totes may be subdivided into multiple sections each of which has multiples of a single SKU. Furthermore, when the order to pick one or more objects is sent to the picking robot, dimension and weight data about the SKU may also be sent. Alternatively, the robot picking system software itself may maintain a database of SKU dimensions. In such applications therefore, the robot picking system can use the dimensions of objects themselves instead of the maximum dimensions to generate the payload guard using any of the approaches described herein. This has the potential to generate significantly smaller payload guard volumes.

In accordance with further aspects, kinematic gripping models may be used to generate payload guards that may be more accurate in certain applications. A more accurate payload guard may be obtained if information about the SKU and the gripper are available. For instance, a vacuum-based gripper with the suction cup 48 typically has bellows that cause the suction cup to deflect as shown in FIG. 9 when holding the object 50 in a way that is not balanced. In this case the suction cup 48 acts like a torsional spring with a Hooke's law for the torque and angular deflection: the torque is proportional to the deflection angle (τ_{cup}=k×θ). Static equilibrium is where the torque from the suction cup 48 balances with the torque due to gravity acting at the center of mass of the object 50.

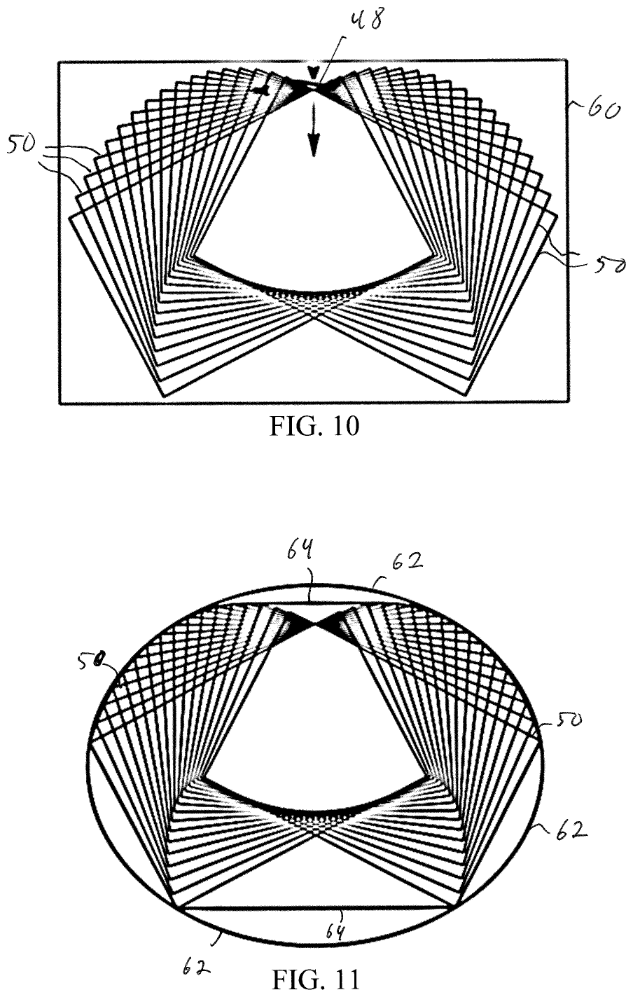

Knowing the dimensions and weight of the object, the system may compute a set of possible grips by varying where on the object the gripper holds the object. FIGS. 10 and 11 for example shows multiple positions of the object 50 and the vacuum cup 48b with respect to the programmable motion device that may be determined by the computer processing system. Then for the payload guard, the system has various options including: (a) using a boundary box 60 that contains the union of the cuboids so generated as shown in FIG. 10; (b) using the smallest ellipsoid containing all the cuboids (shown at 62 in FIG. 11); (c) using the convex hull (shown at 64 in FIG. 11) of the cuboids; and (d) using the union of cuboids so generated (which may be computationally slower). These illustrations are in 2D, but can be easily extended computationally to 3D, and to objects that are not necessarily boxes.

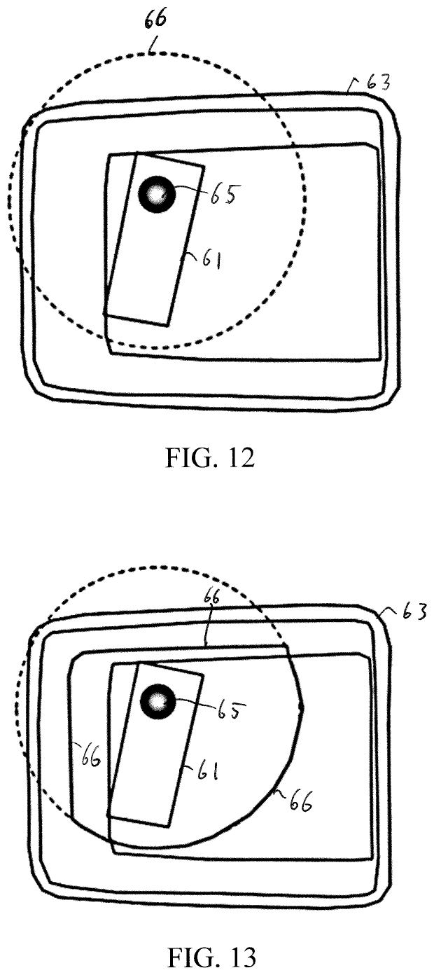

In accordance with further applications, payload guards of an object may be generated, at least in part, based on inferences from the object in situ in a container. For example, the system may logically infer the geometry of the payload guard during the pick. If a SKU of known dimensions is picked from a homogeneous tote then we can intersect the interior volume of the tote with the one of the payload guards calculated above. For example and with reference to FIG. 12, if the robot picks an object 61 from the tote 63 by a vacuum cup at a location shown at 65, then it might infer a cylindrical payload guard based on the object's dimensions as shown at 66 (in top view), e.g., where outline of the object is not known. With reference to FIG. 13, the outline of the object 61 may still be unknown, but because the object is near a wall (two walls in fact) of the tote 63, the system may determine situation-bounded payload guard 68 as a union of the payload guard 66 of FIG. 12 and limitations on available locations of the object due to it's in situ environment (the interior volume of the tote). In other words, the object can be assumed to not extend through any of the walls of the tote 63. The position and orientation may be determined from the same 3D imaging sensors that generate the grasp.

This approach relies on the tote being one of known geometry, and of the system being able to estimate the pose of the tote relative to the coordinate system of the robot. The approach may be generalized: the principle is that the object cannot be found to lie across the boundary of the interior volume of the tote. Therefore, any volume that can be safely assumed to contain all positions and orientations of a SKU can be used as an intersecting volume.

In accordance with further aspects, payload guards may be developed prior to picks based on perception data. The above approaches to generating a payload guard have been based on kinematic principles. In further aspects, the system may consider approaches at generating a payload guard by sensing before the pick, and further after the object has been grasped and lifted.

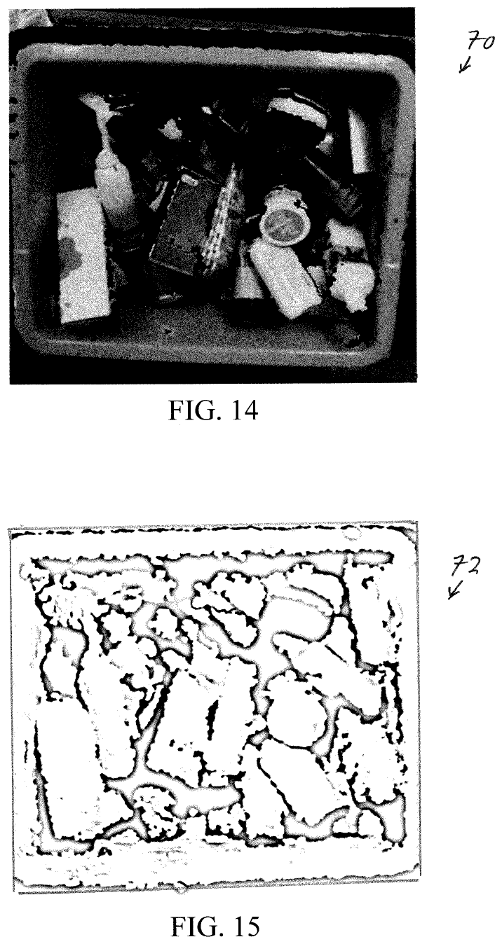

Various segmentation algorithms may be used to segment 3D pointcloud data and 2D imagery. The 3D pointclouds may be segmented using locally convex patches (see for example, Object Partitioning Using Local Convexity, Simon Christoph Stein, Marcus Schoeler, Jeremie Pappon and Florentin Wörgötter, Computer Vision Foundation, CVPR 2014). Deep learning algorithms (see for example, Learning Orientation-Estimation Convolution Neural Network for Building Detection in Optical Remote Sensing Image, Yongliang Chen, arXiv: 1903.05862v1 [cs.CVC] 14 Mar. 2019) can infer the orientations of generic items. These algorithms might be used directly to generate grasps, but may also be used to segment the object from its background in order to generate a payload guard. Shown at 72 in FIG. 15 is an example of such a segmentation of a pointcloud data of the contents of a bin using an image that is shown at 70 in FIG. 14.

Using the segmented tote contents, there are a variety of further ways that the system may construct a payload guard. One way to do so is to center the payload guard on the center of the segment, and to align the long dimension of the payload guard with the long dimension of the segment. This approach however, may not adequately take into account noise and/or occlusion in the segment in certain applications. For example, a segmentation may generally be over-segmented meaning that the system may generate more segments than objects depending on the system's tuning. Another approach is to generate a payload guard from the union of all SKU-sized cuboids that contain the segment. Such a volume can be approximated by sampling.

The pointcloud data from the tote sensor and/or the segmented object may be fed through a deep learning algorithm trained on previous picks generically, or of the same type of object. The deep learning algorithm takes as inputs the tote sensor data and segment data represented as an image, for instance, as well as the expected grasp position and yaw orientation relative to the segment. The output is an estimate of the object bounding box size and pose relative to the gripper. For training purposes, the ground truth object size and relative pose can be ascertained via secondary sensors such as pose in hand. The deep learning model may be trained conservatively, e.g., the model is 99% certain that the payload guard encompasses the item.

In accordance with further aspects, the system may develop a payload guard based on inferences made after picking an object using sensors and pose-in-hand estimation. Certain of the approaches to generating a payload guard before the pick discussed above may be challenged by the presence of clutter in the picking environment, which may make it difficult to visually or geometrically distinguish an object from its background. For example, different segments might overlap multiple objects, which may result in inaccurate payload guards developed prior to picking. Inaccuracies may cause collisions, which could be compensated by adding margins around the payload guard, but which, however, would provide a less tight bound. An alternative or additional approach is for the system to generate the payload guard after the picked object has been removed from the tote.

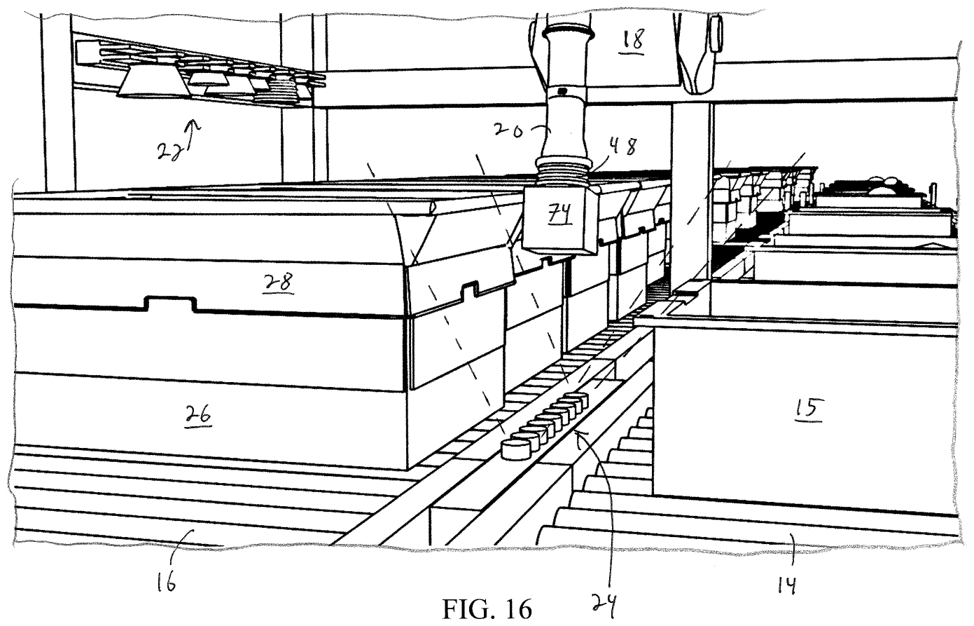

FIG. 16 shows an enlarged view of a portion of the system 10 of FIG. 1 showing the pose-in-hand perception system 24 with a field of view that is directed toward pose-in-hand location of the programmable motion system 18 as shown. The pose-in-hand location may be associated with known positions of the joints of the programmable motion device and the end-effector, providing a defined known position and location of the end-effector at which the volume occupied by the end-effector 20 (and vacuum cup) may be known. The system therefore may scan the object during transfer by stopping at or moving through a pose-in-hand location. The tote 15 is the pick tote, and the container 26 with the cover 28 is the place tote.

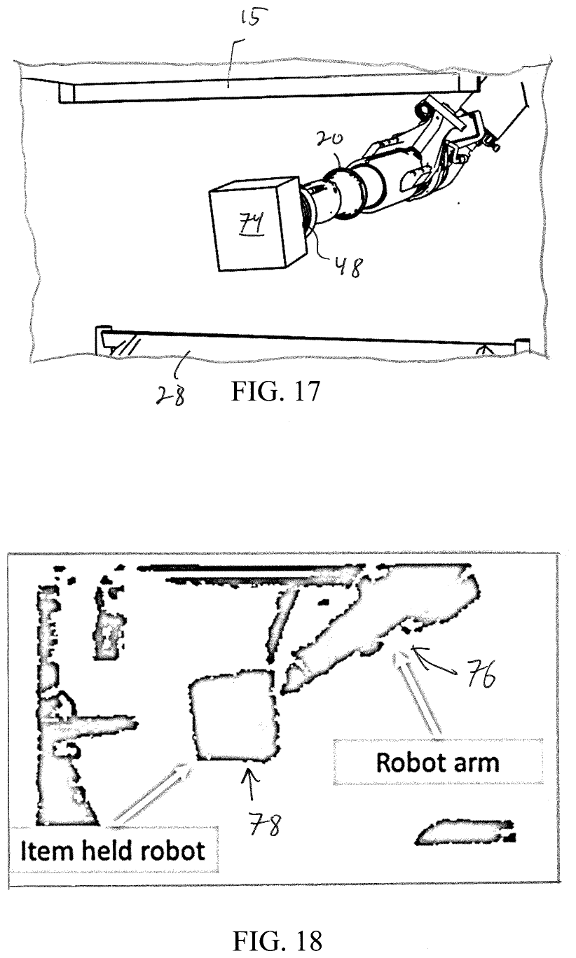

During the transfer from the pick tote to the place tote, a 3D camera or cameras 24 is placed underneath the area where the SKU is transferred in order to capture the pose-in-hand of the object. An object 74 therefore held by the end-effector 20 may be scanned or imaged, and the background including the end-effector 20 may be readily removed since the location and position of the end-effector is known as shown in FIG. 17. FIG. 18 shows the robot and end-effector pointcloud data at 76 and the object pointcloud data at 78. The pointcloud data from the 3D cameras is filtered by depth, so not all points in the background are shown. The object 74 held by the robot is in shown at 78.

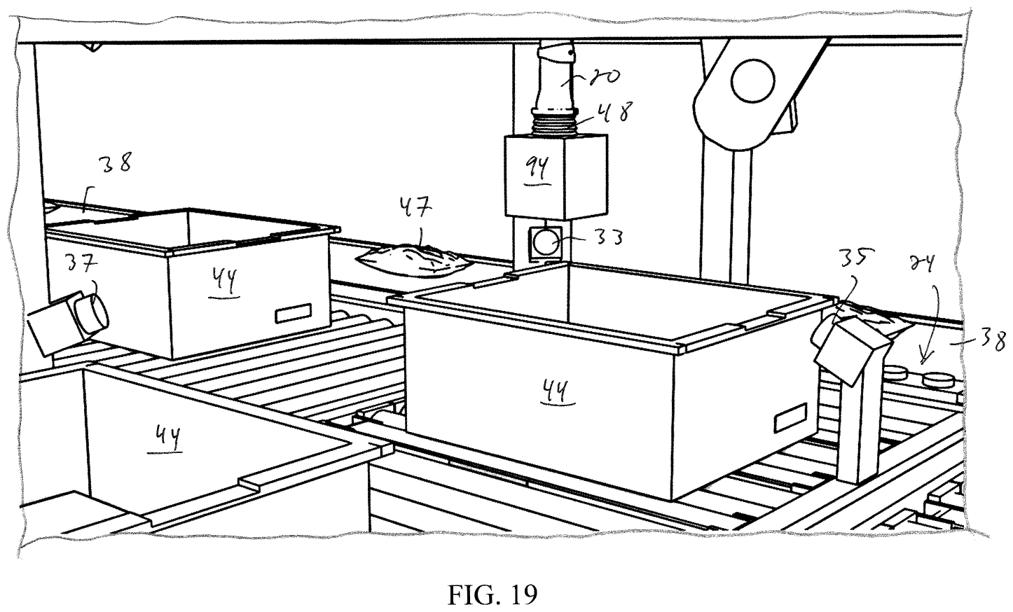

In accordance with further aspects, once the object is removed from the tote, one or more 3D cameras may be used to generate one or more pointclouds of the object from multiple directions. One such layout of sensors is shown in FIG. 19, showing a portion of the system of FIGS. 2 and 3. The positions and orientations of the three cameras 33, 35, 37 is such that as soon as an object is picked and removed from the tote 44 the object is centered in the view of the cameras 33, 35, 37. Again, pointcloud data is captured from each camera 33, 35, 37 in order to obtain information regarding the object 94 from multiple angles.

Whereas approaches described above may only be able to offer a very loose fitting payload guard, capturing the actual volume occupied by the object will generate a much more accurate and tightly fitting payload guard. If the object's dimensions are known, then the sensor data enables estimating the position and orientation of a known size item relative to the gripper. Since this is an estimate of the pose of a known size object relative to the gripper while being held by the gripper, the system may call the transform from a coordinate system for the item to an end-effector coordinate system the pose-in-hand. The pose-in-hand estimate may then be used by the system to generate a payload guard. If the object is unknown at time of grasp (hence dimensions unavailable) then the sensor data may be used to construct a bounding cuboid from dimensions, orientation and position, which becomes the payload guard.

It should be noted, however, that the pose-in-hand estimate and thus tight-fitting payload guard will not be available until the time the item is scanned by the sensors and then calculated from the sensor data. So up to that point, another payload guard generated from one of the previous approaches may have to be used to affect the motion planning up to the pose-in-hand scanning point. This would be required, for example, in the system of FIG. 16 where the pose-in-hand scan is made halfway through the transfer.

In accordance with various aspects therefore, the sequence may operate as follows. After picking an object from a pick tote of homogeneous or heterogeneous SKUs, the robot moves to one of a set of fixed known arm positions, where the scanners are triggered to capture images at that time. In order to plan the move, it may use one of the kinematically-derived payload guards with or without known SKU dimensions. At the time of capture, the robot arm joint configuration is recorded. The images and/or pointclouds are then processed, and the processing may involve a sequence of configurable filters and estimators that are then applied to the pointclouds, at the end of which sequence a pose-in-hand estimate is provided. Filters mask their input cloud and return a new pointcloud of equal or lesser points. An estimator takes a pointcloud and returns a bounding box around such a cloud.

Filters remove extraneous data from the input to the various estimators, and are designed to improve the performance (e.g., processing time) or accuracy of the estimators. Examples of filters include but are not limited to: cropping the pointcloud to a fixed area of 3D space; decimation filters; removing points from the pointcloud in a fixed area in 3D space; removing points known to be a part of the background because background scan data had previously been acquired; removing points known to be part of a known object in space such as a tote or the robot and whose pose may change but whose pose is known from sensors; outlier filters, such as removing isolated points; smoothing filters; or approaches to cluster or segment parts of the cloud and filters on the segments.

Estimators infer from the filtered pointcloud data an estimate of the position and orientation of the object, and may optionally also estimate object dimensions, using for example, deep learning processes. See, e.g., 3D ShapeNets: A Deep Representation for Volumetric Shape Modeling, by Z. Wu, S. Song, A. Khosla, F. Yu, L. Zhang, X. Tang and J. Xiao, Proceedings of 28th IEEE Conference on Computer Vision and Pattern Recognition (CVPR2015). Examples of estimators include but are not limited to: a yaw-based bounding box which flattens a pointcloud along the z-dimension and then calculates the minimum-area oriented bounding box (OBB with length, width, and rotation) to encompass all the points while assuming the height of the OBB is the distance from the bottom of the cloud to the known height of the gripper; a minimum-volume 3D box computed directly on the cloud. Estimators may incorporate and propagate uncertainty about the pose-in-hand estimate, using for example a covariance matrix in the number of dimensions (six for just position and orientation; nine when also including a bounding box's three dimensions); or may represent the uncertainty using samples (as in particle filtering). Such uncertainty however, may be propagated to the payload guard, thus representing a volume greater than that of a single object.

The final bounding box returned by the system is known to be in a given position relative to the robot's end effector. In order to determine this, the system must first convert whatever bounding box is determined from the sensors to the coordinate system of the robot using the sensors' extrinsic parameters. Then, since the robot is at a known state at the time of capture, the item's position and orientation relative to the robot as well as the item's size and shape, the pose-in-hand may then be computed by subtracting the pose of the end-effector. The result provided by the system is the bounding box to end-effector transformation. If multiple sensors are used, then in general they should all be triggered at the same time, e.g., with a common hardware trigger so that all images or pointclouds of the item correspond to the same recorded robot state in time.

As noted above, in accordance with various aspects, the system may perform pose-in-hand scans with the robot stopped at the pose-in-hand location and position, or while moving. If the robot comes to a stop at the pose-in-hand location and position, then the system knows the positions of each of the joints of the robot and therefore the exact location and position of the end-effector. In particular, the robot holds the object, comes to a stop at a known location, and then once the robot is stopped, software can trigger the sensors. Because the robot is stopped, the joint configuration is known accurately.

If, however, the robot did not have to come to a stop, and it could scan while the arm segments were in motion, then the process would determine associations faster resulting in faster robot operations since the robot would not need to decelerate, pause, and then re-accelerate. But to do so, the system would have to accurately acquire the robot's position at the time of the scan. If there is a one cm error in the position of the robot end-effector, then there is at least a corresponding one cm error in the pose-in-hand estimate and payload guard, which leads to inefficiencies (and therefore a need to add margins to compensate). Two sources of inaccuracies are: (a) typically the robot controller provides the robot's state to the processor at a low bandwidth such as 100 Hz; and (b) it may be difficult to determine the time of the scan accurately since the perception units would have to provide direct notification and the system would have to be prepared to instantly receive the direct notification. In the latter case, if the robot is moving at one m/s at the time of scan, and the error in time between when the scan occurred and the time of the joint configuration used is fifty ms, this yields at least a five cm error in pose-in-hand estimate and payload guard.

If the object is scanned in motion, the error distribution on the pose of the end effector is effectively one-dimensional, meaning that the true pose is somewhere along the executed trajectory. The spatial distribution of this error could be incorporated into the payload guard by expanding along the direction that is tangent to the trajectory at the estimated capture time without expanding significantly in orthogonal directions. This leads to a more conservative payload guard than would be produced by expanding uniformly in all directions. In particular, to solve for the time of the scan, the system triggers the camera from a software application, which controls a digital I/O device, which sets a pin high on the sensor(s) for 20 to 80 ms. Various ways then may be used to recover the joint state at the time of trigger, such as the following.

First, the same digital I/O output signal is also wired into the robot controller. The driver on the robot controller can be programmed to record the time of the I/O trigger and the joint state at the time of the trigger, which is then relayed back to the software application via a message. To solve this, the system may interpolate based on the time found above. Assuming time of trigger and time of joint configurations are collected relative to a single clock, and two samples of the joint configuration are known before and after the trigger time, then the joint configuration can be linearly (or higher order) interpolated to get a more precise estimate of the configuration at time of transfer.

Secondly, the software system, immediately after commanding the digital I/O device to trigger, may record the latest joint state received from the robot driver.

Thirdly, if the motions over the scan are consistent, then there may be a contact device mounted on the robot (e.g., the base link of the robot) so that when the first joint of the arm swings through, e.g., 135 degrees, it causes the cameras to trigger. Then, since the scanning trajectory is likely to be monotonic in the base joint, the true joint state at time of trigger, can be look up by interpolating the commanded trajectory as a function of the base joint angle.

In accordance with further aspects, the system may employ multi-shot Scans for Swing Detection. As discussed above, there may be compliance in the end effector (the suction cup may deflect) or the object may be deformable. As a result, the object may swing or otherwise exhibit some kind of dynamics while in motion. In order to detect this motion, multiple scans of the object may be collected in time. For each time instance, a pose-in-hand estimate can be collected and since the joint configurations should be known, the motion and swinging relative to the end-effector can be estimated. Further motion could be extrapolated using a pendulum model or other dynamic model derived from the mechanics of the gripper. The measured and optionally extrapolated volumes can then be used to enlarge the payload guard, by taking the union of the volumes. Further, the detection of significant swinging (as determined by there being enough swinging to put a motion at risk of collision), may be used by the system to reduce the speed of motions. This multi-shot data could additionally be used to train the parameters of SKU-specific deformability models. Such models could then be used for payload guard estimation prior to capturing pose-in-hand data (e.g., the payload guard could be used when planning the trajectory from the initial grasp to the pose-in-hand data capture configuration). The payload for a rigid-in-hand item would be smaller than the payload guard for an object of equal size but greater deformability in hand.

In accordance with further aspects, the system may employ size lookup tables for pre-computed trajectories. In order to optimize the time needed to plan robotic motions and trajectories, the system may pre-compute various motions ahead of time, to offload the computation time needed during real-time operations. In particular, for robotics trajectories that may be executed while holding a SKU, there can be many discretized options for which trajectory may be chosen, based on factors such as (a) the size of the given object picked, which is most important for ensuring collision-free trajectories of the item with the environment, and/or (b) the orientation of such an object relative to the gripper while being held (pose-in-hand), which is also important for ensuring collision-free trajectories, but is also important in some cases for determining how to fit an object in a tight-fitting container/box/etc. Based on the detected pose in hand results, the system may intelligently select a pre-computed trajectory that matches the needs of the way the system is holding the given object at that time.

In accordance with further aspects, the system may employ a technique of relaxing margin parameters to avoid motion planning failures. The concept of relaxing constraints can be employed. In order to compute successful, collision-free trajectories, the system may in some cases assume a more conservative payload guard to start, where if that succeeds then the system will note that this most nominal case provides the safest trajectory. If however, that does not succeed, the system may iteratively relax constraints, up to a given limit, such that the chances of finding a successful solution are improved, while maintaining the optimal solution in the nominal case.

In accordance with further aspects, the system may employ a technique of satisficing placements. In some applications, there may be expected to be many acceptable solutions for any generic robotic trajectory with a payload guard. For example, it may be desired to make sure an object when it is transferred, is fully contained within a destination tote. The system may encode the goal of motion planning to ensure that the payload guard (no matter how constructed) lies within the destination tote's walls. Then, after a successfully executed placement, the object should lie within the tote. If the object is much smaller than the tote, then very many valid placements may be made (e.g., some to a far part of the tote, some to a near part of the tote). The system may further be encoded to generate many hypothetical placements that satisfy the goal of having the payload guard within the tote; then determine which hypothetical placements have viable, otherwise collision-free trajectories; then, choose among those plans the ones that are best according to a criteria such as speed or distance. This is referred to herein as satisfiability, or selecting the most optimal solution among many acceptable options.

In accordance with further aspects, the system may employ techniques for adjusting for substantially off-gantry grasps. One of the factors on the shape of the payload guard is the nature of the robot's motion when gripping the payload. Primarily the system has assumed that the gripper makes gantry motions, that is, it does not roll or pitch. However, if the robot gripper rolls or pitches substantially (e.g., more than 30 degrees), then for some suction cup grasps, the payload guard should roll or pitch with it.

Further, if the robot had to circumvent an obstacle in the environment by rolling more than 90 degrees to put something into a slot, for example, or if it had to roll 90 degrees for a scan-in-hand to point a barcode upwards, then the kinematically derived payload guard should take into account the mechanical properties of the gripper. Heavy or non-rigid objects will tend to deflect or rotate opposite the direction of the robot gripper's roll or pitch, so as to minimize the energy of the system. The amount of deflection of the payload guard as a function of angle from vertical can be derived by finding the equilibrium angle that balances the torque due to the cup and gravity.

In accordance with further aspects, the system may employ the empirical payload guards using pose-in-hand estimates. In particular, if a system has pose-in-hand scanning sensors, then the pre-pose-in-hand payload guard can be improved by utilizing a collection of post-pose-in-hand representatives. In other words, instead of using a potentially overly large payload guard, the system may construct a probabilistic occupancy grid in the coordinate system of the gripper and calculate the probability of a given voxel being occupied from the pose-in-hand estimates. Each voxel's probability of being occupied is the fraction of cuboids that contain it. Then, the payload guard can be defined as the set of voxels whose probability of occupancy is greater than, for example, 99%. In order to implement this, some systems may be designed to have pose-in-hand scanners, or it may be that there are certain systems used for training or evaluation that have pose-in-hand scanning sensors. These system may collect this probabilistic payload guard information for use by other systems.

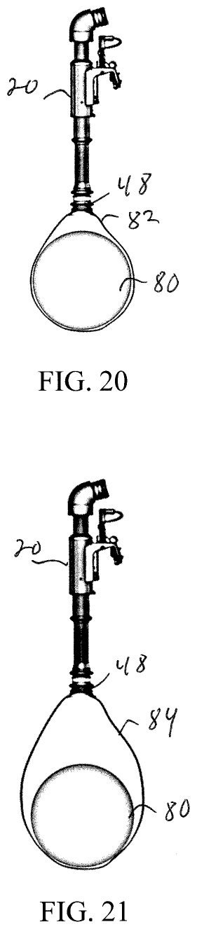

In accordance with further aspects, the system may employ teardrop models of bagged objects. Objects that are in bags (or are bags themselves) tend not to behave like rigid objects. There are options for employing payload guards: (1) knowing ahead of time that the object is a bag and employing a geometric model specifically adapted to bags; (2) inferring from sensor data that the object is a bag and then employing a geometric model specifically adapted to bags; or (3) not having any prior or sensible information about bags, but using a geometric model of bags as part of a worst-case envelope. FIG. 20 shows the end-effector 20 with the vacuum cup 48 grasping an item 80 within a bag 82. FIG. 21 shows the end-effector 20 with the vacuum cup 48 grasping the same item 80 within a larger bag 84, showing that the bag 84 may swing substantially during processing.

A possible geometric model for bags is a teardrop-like model with two parameters: (1) the surface area of the item inside the bag; and (2) the surface area of the enclosing bag. The ratio of these parameters determines how much the item drops, and other dynamic properties such as how much the item may swing (period of a pendulum only depends on the length of the pendulum). In any case, the swept volume of the possible swing states (2D angles, roll and pitch) can be used to generate a payload guard.

In accordance with further aspects, the system may employ pick verification by checking how many objects have been grasped by the robot out of a tote or other container. It is generally desired for the robot to only pick one object, and so a verification step is put into place to ensure that one and only one object has been picked, and if determined to be more than one object, then the objects are put back into the tote. The system receives a 3D point cloud of the product from the depth camera and tries to fit the point cloud inside a boundary box, which is a cuboid with the length, width and height dimensions of the SKU retrieved from a database.

In the case of one pointcloud sensor obtaining data from below the gripper, because the one pointcloud sensor is only able to see the bottom side of the product, the point cloud of the product is complemented with a point centered on the suction cup. Then, the system checks multiple orientations and positions for which the complemented pointcloud (the one with the added point) fits inside the boundary box. If the system cannot find a pose for the cuboid that encloses the pointcloud, then the pick is deemed to have picked more than one item, and the object(s) are put back into the source tote. Margins may be added to the dimensions in order to reduce the occurrence of false positives and balance them with false negatives.

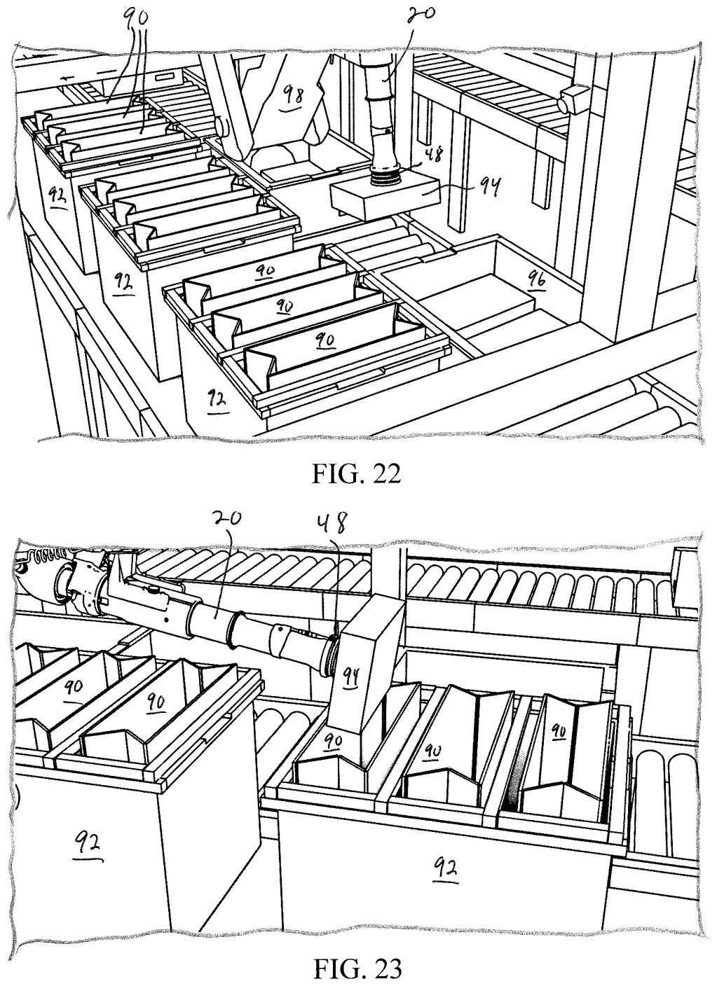

In accordance with further aspects, the system may provide payload guards in connection with placement of objects into bags. An example application is one in which a robot picks SKUs out of homogeneous or heterogeneous totes and places items directly into grocery bags, in order to fulfill customer orders. Totes containing inventory are conveyed to the system, e.g., by conveyor, wherein the totes each contain for example three grocery bags as shown in FIG. 22. The three grocery bags 90 in each tote 92 may correspond to one or more customer orders. The robot's job is to transfer individual objects 94 from inventory tote 96 to grocery bag 90. The system is commanded to fulfill specific SKUs by a WMS. FIG. 23 shows the robot arm 98 rolling the object 94 in order to fit it sideways into the grocery bag 90.

The system is able to pick objects out of inventory totes 96, and it needs to determine a trajectory that places a picked item into one of the three grocery bags. The trajectory is calculated using the place planner. In accordance with certain aspects, three plastic bags may be stretched over the outbound tote, and each bag has an opening of, for example, roughly 15 cm×34 cm with a depth of about 30 cm. The place planner solves the following. The place planner finds trajectories that place items into the grocery bags so as to avoid snagging the grocery bag with the SKU (if the SKU snags, it may rip the bag.) Further, the SKU's largest dimension may be larger than the opening of the bag, so the Place Planner may have to calculate re-orientations of the SKU to insert it into the bag. Further, yawing the item may not be sufficient. Some SKUs and some ways in which they are grasped may further require the gripper to roll the SKU so as to fit it into the slot. Therefore the planner is able to execute roll and/or pitch-based planning to place items into bags. Further, the place planner must also avoid overfilling the grocery bags because that would cause delays or require human intervention. The place planner uses the pose-in-hand estimates and compensates for the free and non-free space within bags as well as the dynamics of placing items.

The workflow for example, may the following. First, a SKU is picked from an inventory tote. The SKU is moved from the picking location to the pose-in-hand scanning location in the robot cell using motion planning algorithms that employ a kinematically-derived payload guard (i.e., not based on sensor data).

Next, at the pose-in-hand scanning location a bounding box of the volume held by the gripper is determined. Both the pose of the bounding box relative to the gripper is determined, as well as the dimensions of the bounding box.

Optionally the dimensions of the bounding box are then compared to the known dimensions of the SKU. If the observed dimensions or volume exceed the known values, then it can be deemed to be holding more than one SKU, in which case the robot returns the SKU to the tote.

In parallel, the place tote (grocery bags) are scanned to obtain a pointcloud. From the pointcloud a heightmap is generated of the place bag area (i.e., a discretized grid of heights above the tote floor). This involves performing pointcloud filtering (via clustering/ML methods) to remove corners' that stretch across the corners of the plastic bags. In addition, the edges of the pointcloud are filtered out with the expectation that items will be large enough to be seen even with edge filtering.

Next, candidate SKU place poses that will not overfill the container are generated using the heightmap. There is a first preferential set of candidates that do not involve rolling the gripper, followed by a second set which may involve pitching or rolling the gripper (and are slower). The purpose is to generate multiple possibilities because some poses may not be achievable—no trajectories can be found because of collision, for example.

To do this, the system first considers yawing the SKU, i.e., rotating the SKU about the axis of the gripper. Two item poses corresponding to four robot poses are tested where the bounding box axes with the longest horizontal to parallel and perpendicular to the bag. Second, if no placements in the first set are found, the system rolls the item by 90 degrees and again considers two yaws 90 degrees apart. More than one robot yaw per object may be considered since there are other constraints at play such as feasibility and object drop height. In all cases, the system aligns the base of the rolled bounding box with the rectangular slot corresponding to the grocery bag. This results in a set of candidate placement poses to be sent to motion planning algorithms in the next steps.

Each candidate SKU place pose is used to generate corresponding candidate robot place poses. Note that many of these robot place poses (especially for rolled placements) are not feasible. The system concurrently plans in the robot's joint space from the pose in hand node to the robot place poses. The system also plans from those configurations to the robot place pose candidates in workspace and tries to get as close as possible to the candidate robot place pose while avoiding collisions. The system then executes the chosen trajectory. These measures result in rolled placements that are accurate to ˜1-2 cm experimentally.

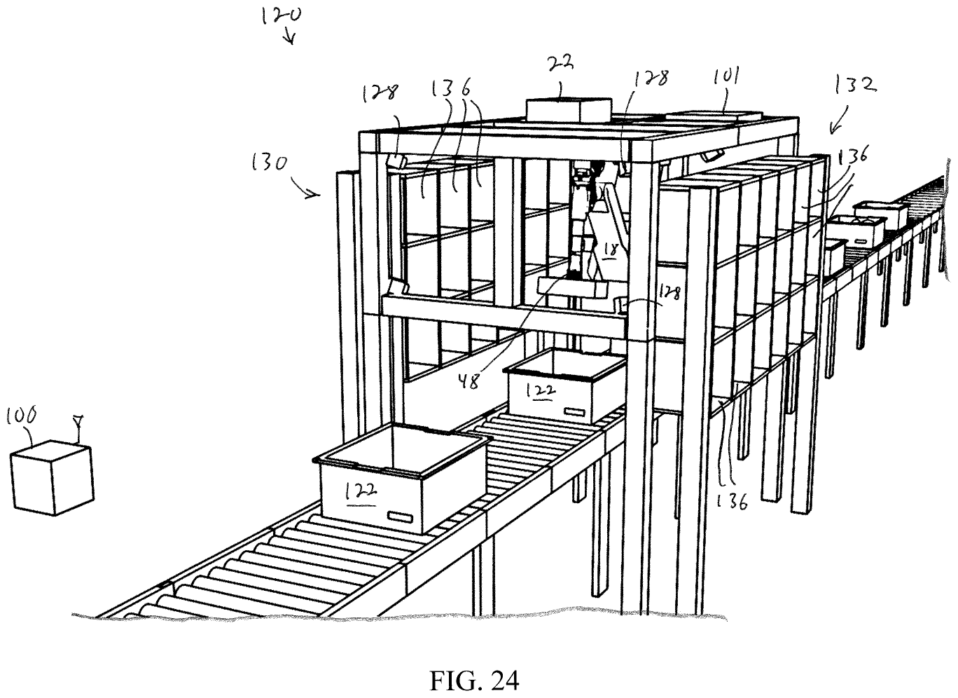

In accordance with further aspects, the invention provides that the system may develop payload guards in connection with placement of objects into cubbies or chutes. In particular, the application is, for example, sorting goods into cubbies that correspond to customer orders. The wall of open cubic cells (or cubbies) is known as a putwall; this application is a dual robotic putwall. With reference to FIG. 24, an object processing system 120 includes the robotic arm 18 with the end-effector 20 having a vacuum cup 48 that is used to pick objects from infeed totes 122 on in-feed conveyor 124 and place the objects into an open cubic cell 136 that is provided in one of two arrays of open cubic cells 130, 132. Human personnel may remove objects from the cubic cells, or in accordance with further aspects, the open cubic cells may be provided as chutes that lead to further processing locations.

The robot 18 picks a SKU out of a heterogeneous tote 128, scans its barcode using any of a plurality of scanners 134, and on the basis of the decoded barcode, determines which cubby to place the SKU into, and then executes the placement. In general it is desirable to have as many cubbies as can be reliably and accurately placed into by the robot as doing so increases the efficiency of picking items from shelves. The payload guard can be used to place the item into the cubby and so having a more tightly fitting payload guard will enable a greater number of cubbies.

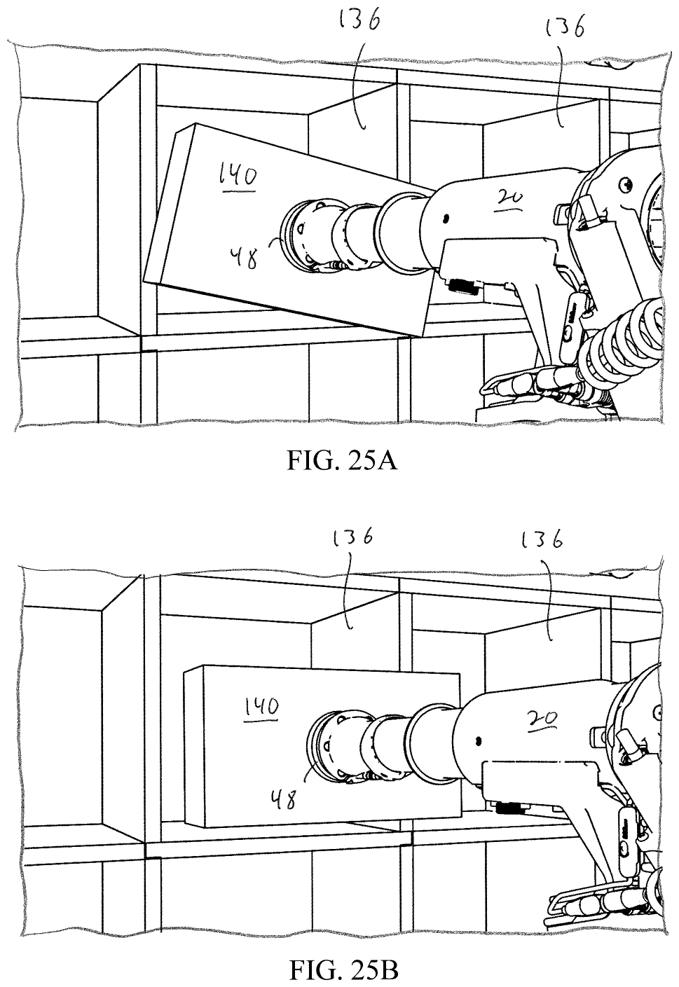

With reference to FIG. 25A, the system uses the pose-in-hand information (together with the device 18 joint information) to know that certain placement approaches to a selected cubbie 136 may not be workable (not fit), while others as shown in FIG. 25B will work. The system has information regarding the sizes and locations of all cubbies and uses the pose-in-hand information to ensure that objects (e.g., object 140) are placed into the cubbies with placement poses that will fit.

The processing steps may be as follows. The robot picks one of the SKUs from the heterogeneous tote. Then, upon being lifted out of the tote, the robot uses an array of barcode scanners 128 in the workstation to scan the barcode on the SKU. If the barcode is not found, it places it back into the tote, for example, or into a separate processing location such as cubbie designated as an exceptions cubbie. If multiple barcodes are found, indicating multiple SKUs were picked, then the SKU(s) is/are put back into the tote.

If the barcode is found, then the system will construct a payload guard using one of three methods. First. if pose-in-hand scanners are not available, and if dimensions are not known for the SKU, then a worst-case payload guard is constructed from the maximum handleable dimensions of the robot. Second, if pose-in-hand scanners are not available, and if dimensions are known for the SKU, then a worst-case payload guard is constructed from the SKU's known dimensions. Third if pose-in-hand scanners are available then a cuboid or other fitting geometry is used as payload guard.

With the payload guard now constructed, the system plans a trajectory starting from wherever the robot is after the pose-in-hand scan to the goal which is a placement within the desired putwall cubby 130, 132. A placement can be defined to be one where the payload guard is fitted within the rectangle of the entry to the cubby, and substantially beyond the front plane of the putwall where substantially might mean for example any of the following: one, that the payload guard is beyond the front plane; two, that the payload guard's rear edge sticks out at most some distance from the front putwall plane; or three that the payload guard center is at least some distance beyond the front plane. Other manipulations of the payload guard may be employed so that a virtual placement defined for the purposes of motion planning results in a successful placement into the proper cubby, without jamming the SKU, and without it resulting in the wrong cubby. Other techniques can be used here as well such as satisfiability and mechanical models of the gripper for trajectories that might require substantial pitching. The robot then executes the trajectory to place the object, and the system repeats until the tote is empty, and waits for a new tote.

Those skilled in the art sill appreciate that numerous modifications and variations may be made to the above disclosed embodiments without departing from the spirit and scope of the present invention.

What is claimed is:

1. A system for processing objects using a programmable motion device, said system comprising:
an end-effector of the programmable motion device for grasping an object from an in-feed container; and
a control system for determining a payload guard for the selected object, said payload guard comprising pointcloud data regarding volumetric data that include a volume occupied by the selected object, said payload guard being determined responsive to at least one characteristic of the selected object and is provided specific to the selected object.

2. The system as claimed in claim 1, wherein the payload guard is provided as an axis-aligned bounding box.

3. The system as claimed in claim 1, wherein the payload guard is provided as an axis-aligned bounding cylinder.

4. The system as claimed in claim 1, wherein the system is able to detect deflection data representative of deflection of a vacuum cup attached to the end-effector and holding the selected object, and wherein the payload guard is provided responsive to the detected deflection data.

5. The system as claimed in claim 1, wherein the end-effector includes a vacuum cup of a diameter d, and wherein the payload guard is reduced in at least one dimension by a distance on the order of the diameter d.

6. The system as claimed in claim 1, wherein the payload guard is provided based on perception data of the object when the selected object is lifted from the in-feed container.

7. The system as claimed in claim 1, wherein the payload guard is provided based on perception data of the selected object when the selected object is being held at a defined location.

8. The system as claimed in claim 1, wherein the payload guard is provided based on perception data of the selected object when the selected object is moved through a defined location.

9. The system as claimed in claim 1, wherein the payload guard for the selected object is determined at least in part, on a location within the in-feed container occupied by the selected object prior to grasping.

10. The system as claimed in claim 9, wherein the location within the in-feed container occupied by the selected object prior to grasping is a location adjacent a wall of the in-feed container.

11. The system as claimed in claim 1, wherein the system is able to detect swing data representative of swing of the selected object, and wherein the payload guard is provided responsive to the detected swing data.

12. The system as claimed in claim 1, wherein the payload guard is provided in a generally teardrop shape responsive to perception data indicating that the selected object includes a non-rigid bag.

13. The system as claimed in claim 1, wherein the payload guard incorporates placement restrictions regarding the location in which the selected object is to be placed by the programmable motion device.

14. The system as claimed in claim 13, wherein the placement restrictions include any of a horizontal or vertical defined opening.

15. A method of processing objects using a programmable motion device, said method comprising:
grasping an object from an in-feed container using an end-effector of the programmable motion device;
lifting the object from the in-feed container; and
determining a payload guard for the grasped object, said payload guard is derived from pointcloud data regarding volumetric data that include a volume occupied by the grasped object, said payload guard being determined responsive to at least one characteristic of the grasped object and is provided specific to the grasped object.

16. The method of claim 15, wherein the payload guard for the object is determined when the grasped object is being held by the end-effector.

17. The method of claim 15, wherein the payload guard is provided as an axis-aligned bounding box.

18. The method of claim 15, wherein the payload guard is provided as an axis-aligned bounding cylinder.

19. The method of claim 15, wherein the method further includes detecting data representative of deflection of a vacuum cup attached to the end-effector and holding the grasped object, and the determining the payload guard is responsive to the detected deflection data.

20. The method of claim 15, wherein the end-effector includes a vacuum cup of a diameter d, and wherein the payload guard is reduced in at least one dimension by a distance on the order of the diameter d.

21. The method of claim 15, wherein the payload guard is provided based on perception data of the grasped object when the object is lifted from the in-feed container.

22. The method of claim 15, wherein the payload guard is provided based on perception data of the grasped object when the object is being held at a defined location.

23. The method of claim 15, wherein the payload guard is provided based on perception data of the grasped object when the object is moved through a defined location.

24. The method of claim 15, wherein the payload guard is provided limited by at least a portion of the infeed container when the grasped object is positioned near a wall of the in-feed container.

25. The method of claim 15, wherein the method further includes detecting swing data representative of swing of the grasped object, and the determining the payload guard is responsive to the detected swing data.

26. The method of claim 15, wherein the payload guard is provided in a generally teardrop shape responsive to perception data indicating that the grasped object includes a non-rigid bag.

27. The method of claim 15, wherein the payload guard incorporates placement restrictions regarding the location in which the grasped object is to be placed by the programmable motion device.

28. The method of claim 27, wherein the placement restrictions include any of a horizontal or vertical defined opening.

29. A system for processing objects using a programmable motion device, said system comprising:
an end-effector of the programmable motion device for grasping an object;
a perception system for determining perception data regarding the object; and
a control system for determining a payload guard for the grasped object, said payload guard is derived from pointcloud data regarding volumetric data that include a volume occupied by the grasped object, said payload guard being determined responsive to the perception data.

30. The system as claimed in claim 29, wherein the perception data is obtained when the grasped object is lifted from the in-feed container.

31. The system as claimed in claim 29, wherein the perception data is obtained when the grasped object is being held at a defined location.

32. The system as claimed in claim 29, wherein the perception data is obtained when the grasped object is moved through a defined location.

33. The system as claimed in claim 29, wherein the perception data includes detected swing data regarding movement of the object when the end-effector is not moving.
